(19) United States
(12) Patent Application Publication
(10) Pub. No.: US 2026/0362465 A1
(43) Pub. Date: Nov. 12, 2026

(54) MRC/SISO RECEPTION MODE SELECTION

(71) Applicant: Intel Corporation, Santa Clara, CA (US)

(72) Inventors: Yoav Eisenberg, Yehud-Monosson (IL); Avishay Friedman, Petach Tikva (IL); Ronen Mayrench, Raanana (IL)

(21) Appl. No.: 19/093,493

(22) Filed: Mar. 28, 2025

(51) Int. Cl. H04W 72/541; H04B 7/08; H04B 17/336; H04W 88/06

(52) U.S. Cl. CPC H04W 72/541; H04B 7/0874; H04B 17/336; H04W 88/06

(57) ABSTRACT

An apparatus, including: a plurality of antenna chains configured to receive a wireless signal; and processor circuitry configured to: estimate respective signal-to-noise ratios (SNRs) for the plurality of antenna chains based on a preamble portion of a received wireless packet; and select, for the received wireless packet: (a) a single-input single-output (SISO) reception mode in which reception is performed via one of the plurality of antenna chains, or (b) a maximum ratio combining (MRC) reception mode in which reception is performed via the plurality of antenna chains, based on the estimated SNRs.

### BACKGROUND

Maximum Ratio Combining (MRC) is a well-known multi-antenna reception technique capable of providing substantial performance improvements in wireless communication channels. It achieves these improvements by leveraging diversity across multiple antennas and reducing noise correlation between antennas. However, implementing MRC requires operating multiple antennas simultaneously, resulting in the consumption of additional resources such as radio frequency (RF) chains, and increased power consumption, typically scaling linearly with the number of active antennas.

Despite the requirement of additional resources for MRC operation, the performance gains are not guaranteed under all channel conditions. For a significant portion of operational scenarios, single antenna (single-input and single-output (SISO)) reception provides adequate performance for the correct decoding of wireless packets. Under these conditions, activating multiple antennas through MRC unnecessarily consumes power and occupies additional resources without providing a meaningful benefit.

Further, in multi-communication products, multiple wireless communication technologies, such as Bluetooth and Wi-Fi, frequently share transmission and reception resources. This sharing can introduce coexistence issues stemming from common antenna usage, shared analog/RF components, and self-interference from transmission operations impacting reception performance. Such coexistence problems can degrade the performance of the wireless systems involved. For instance, consider a combined Wi-Fi and Bluetooth device supporting dual-chain reception (e.g., MRC or multiple-input and multiple-output (MIMO)) for both technologies, which share antennas and/or analog components. During Bluetooth packet reception, the receiver estimates certain parameters at the packet's onset and then demodulates the received data based on these estimates. If, however, during Bluetooth packet reception, one of the reception chains becomes unavailable due to its allocation to Wi-Fi operation, the Bluetooth dual-chain receiver might fail to successfully complete packet decoding.

### BRIEF DESCRIPTION OF THE FIGURES

FIG. 1 illustrates a block diagram of a dynamic Maximal Ratio Combining (MRC) versus single antenna (SISO) selection architecture, in accordance with aspects of the disclosure.

FIG. 2 illustrates a performance curve of Packet Error Rate (PER) versus Signal-to-Noise Ratio (SNR) of Bluetooth High Data Throughput, in accordance with aspects of the disclosure.

FIG. 3 illustrates a probability curve of single receive antenna (SISO) reception mode selection versus SNR, in accordance with aspects of the disclosure.

FIG. 4 illustrates a block diagram of a multi-technology communication device with receiver mitigation, in accordance with aspects of the disclosure.

FIG. 5 illustrates a timing diagram of Bluetooth transition from MRC to SISO, in accordance with aspects of the disclosure.

FIG. 6 illustrates a communication device, in accordance with the disclosure.

### DETAILED DESCRIPTION

The present disclosure addresses the inefficiency of Maximal Ratio Combining (MRC) when single antenna (SISO) reception would provide adequate performance. A dynamic selection algorithm is introduced, which selectively activates the MRC reception mode only when it delivers tangible performance gains for packet reception. When channel conditions permit successful decoding with a single antenna, the algorithm disables MRC, thus conserving power and freeing up resources. Further, the present disclosure introduces a mitigation strategy to effectively handle scenarios in which, during Bluetooth packet reception, one of the reception chains becomes unavailable due to its allocation to another communication protocol, such as Wi-Fi.

Conventional systems typically rely on SNR and/or PER metrics—calculated based on previously received packets—to determine whether to operate in SISO or MRC reception mode for the next receive opportunity. The MRC scheme is enabled only when the estimated channel condition indicates a need for the additional antenna chain, such as at a cell edge.

However, because Bluetooth operates using frequency hopping and one of its nodes is often mobile (e.g., an earphone), channel conditions can vary significantly over time. As a result, it is challenging to accurately select an appropriate reception scheme in advance for the next packet. In addition, spatial noise correlation is highly dynamic due to factors such as platform noise and external interference, making reliance on historical statistics unreliable.

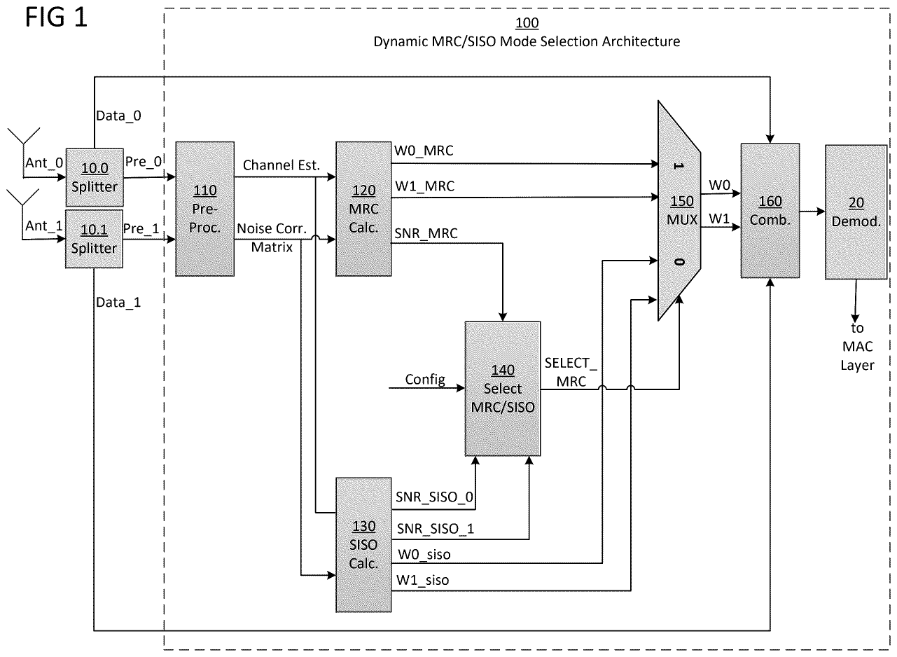

FIG. 1 illustrates a block diagram of a dynamic Maximal Ratio Combining (MRC) versus single antenna (SISO) selection architecture 100, in accordance with aspects of the disclosure.

The dynamic MRC/SISO selection architecture 100 disclosed herein provides for dynamic selection of a reception scheme—either MRC or SISO—based on the condition of the currently received packet. Using the Bluetooth preamble, the post-processing SNR is estimated for each reception scheme, accounting for both the channel state and noise correlation. If the SNR of any individual antenna chain is sufficient to correctly decode the current packet, or if the expected gain from applying MRC is not substantial, the MRC/SISO selection architecture 100 selects the antenna chain with the higher SNR and operates in SISO reception mode.

Each packet reception begins with both antenna chains enabled. Upon detecting a packet, several metrics are computed using the preamble of the received packet. Based on these metrics, the MRC/SISO selection architecture 100 determines whether to retain both antenna chains in MRC reception mode—if a performance gain is expected—or to disable the weaker antenna and continue in SISO reception mode using only the stronger antenna chain. This reduces power consumption and frees the deactivated antenna chain for other purposes, such as concurrent Bluetooth operations or Wi-Fi usage. In most cases, the power savings can reach approximately 50% of the Bluetooth receive chain consumption, reducing power from 24 mW to 12 mW.

The dynamic MRC/SISO reception mode selection architecture 100 includes two antenna chains for receiving wireless signals. The architecture 100 includes splitters 10.0 and 10.1 that receive input from respective antennas Ant_0 and Ant_1 and split the signals into preamble (Pre_0, Pre_1) and data (Data_0, Data_1) paths.

A pre-processing block 110 processes the preamble signals to perform channel estimation and generate a noise correlation matrix. The channel estimation and noise correlation matrix outputs feed into both an MRC calculations block 120 and a SISO calculation block 130.

The MRC calculations block 120 generates MRC weights (W0_MRC, W1_MRC) and an estimated post-MRC SNR (SNR_MRC). The SISO calculations block 130 generates SISO weights (W0_SISO, W1_SISO) and individual SNR values for each antenna chain (SNR_SISO_0, SNR_SISO_1).

An MRC/SISO selection block 140 receives configuration parameters and the various SNR metrics to dynamically select between MRC and SISO reception modes. The selection output controls a multiplexer 150 that selects between the MRC and SISO weights. A combiner 160 applies the selected weights to the data signals from both antenna chains. The weighted and combined output is then provided to a demodulator 20, which connects to the MAC layer.

The selection is made by comparing three SNR metrics: SNR₀: SNR using chain A (SISO), SNR₁: SNR using chain B (SISO), and SNR_{MRC}: estimated post-MRC SNR. At least two criteria are used to decide between SISO and MRC reception modes:
1. Absolute Threshold Criterion: If the higher of the two SISO SNRs is greater than a predefined absolute threshold sufficient for successful packet decoding, the MRC/SISO selection architecture 100 opts for SISO reception mode to save power, deactivating the lower-SNR chain.
2. Relative Gain Criterion: If the estimated post-MRC SNR is not significantly greater than the higher SISO SNR of the antenna chains—either because one antenna is significantly stronger than the other, or due to highly correlated noise across antennas—the MRC/SISO selection architecture 100 also prefers SISO reception mode, maintaining only the antenna chain with the higher SNR.

The SNR is defined as:

$$S N {R}_{i} = \frac{\vert {H}_{i} {\vert}^{2}}{{R}_{i i}} , \qquad Equation ( 1 )$$

where Hᵢ the channel gain in channel i and Rᵢᵢ is the noise power in channel i.

It is often more practical to represent SNR in decibels (dB):

$$S N {R}_{i} [ dB ] = 10 {log}_{10} ( \frac{\vert {H}_{i} {\vert}^{2}}{{R}_{i i}} ) = 10 {log}_{10} ( {H}_{i} {H}_{i}^{*} ) - 10 {log}_{10} ( {R}_{i i} ) . \qquad Equation ( 2 )$$

For MRC, the estimated post-processing SNR is calculated using the maximum likelihood (ML) or minimum mean square error (MMSE) combiner formula:

$${y}_{c} = \frac{{\hat{h}}^{H} {\hat{R}}_{n n}^{- 1} y}{{\hat{h}}^{H} {\hat{R}}_{n n}^{- 1} \hat{h} + 1} \qquad Equation ( 3 )$$

The inverted \hat{R}ₙₙ matrix is given by:

$${\hat{R}}_{n n} = ( \begin{matrix}{\hat{σ}}_{0}^{2} & {\hat{σ}}_{01} \\ {\hat{σ}}_{01}^{*} & {\hat{σ}}_{1}^{2}\end{matrix} ) {\to }^{{( \cdot )}^{- 1}} {\hat{R}}_{n n}^{- 1} \frac{1}{\vert {\hat{R}}_{n n} \vert} ( \begin{matrix}{\hat{σ}}_{1}^{2} & - {\hat{σ}}_{01} \\ - {\hat{σ}}_{01}^{*} & {\hat{σ}}_{0}^{2}\end{matrix} ) , \qquad Equation ( 4 )$$

where:

$$\vert {\hat{R}}_{n n} \vert = {\hat{σ}}_{0}^{2} {\hat{σ}}_{1}^{2} - \vert {\hat{σ}}_{01} {\vert}^{2} . \qquad Equation ( 5 )$$

The estimated post-processing SNR can be simplified as follows (excluding the “+1” term in the denominator for clarity):

$${y}_{c} = \frac{{\hat{h}}^{H} {\hat{R}}_{n n}^{- 1} y}{{\hat{h}}^{H} {\hat{R}}_{n n}^{- 1} \hat{h}} = \frac{{\hat{h}}^{H} {\hat{R}}_{n n}^{- 1}}{{\hat{h}}^{H} {\hat{R}}_{n n}^{- 1} \hat{h}} ( hx + \tilde{n} ) = x + \frac{{\hat{h}}^{H} {\hat{R}}_{n n}^{- 1}}{{\hat{h}}^{H} {\hat{R}}_{n n}^{- 1} \hat{h}} \tilde{n} = x + n \qquad Equation ( 6 )$$

$${σ}_{n}^{2} = E \{ {nn}^{*} \} = E \{ \frac{{\hat{h}}^{H} {\hat{R}}_{n n}^{- 1}}{{\hat{h}}^{H} {\hat{R}}_{n n}^{- 1} \hat{h}} \tilde{n} {\tilde{n}}^{H} \frac{{\hat{R}}_{n n}^{- 1} \hat{h}}{{\hat{h}}^{H} {\hat{R}}_{n n}^{- 1} \hat{h}} \} = \frac{{\hat{h}}^{H} {\hat{R}}_{n n}^{- 1}}{{\hat{h}}^{H} {\hat{R}}_{n n}^{- 1} \hat{h}} {R}_{nn} \frac{{\hat{R}}_{n n}^{- 1} \hat{h}}{{\hat{h}}^{H} {\hat{R}}_{n n}^{- 1} \hat{h}} = \frac{{\hat{h}}^{H} {\hat{R}}_{n n}^{- 1} \hat{h}}{{\vert {\hat{h}}^{H} {\hat{R}}_{n n}^{- 1} \hat{h} \vert}^{2}} = \frac{1}{{\hat{h}}^{H} {\hat{R}}_{n n}^{- 1} \hat{h}} = \frac{\vert {R}_{nn} \vert}{D} \to SNR = \frac{{σ}_{x}^{2}}{{σ}_{n}^{2}} = \frac{1}{\frac{\vert {R}_{nn} \vert}{D}} = \frac{D}{\vert {R}_{nn} \vert}$$

$$- SNR [ dB ] = - 10 {log}_{10} ( \frac{D}{\vert {R}_{nn} \vert} ) = 10 {log}_{10} ( \vert {R}_{nn} \vert ) - 10 {log}_{10} ( D )$$

That is, the estimated post-processing SNR in dB is approximated by subtracting the denominator term from the determinant term used during MRC weight calculation.

This SNR calculation is only accurate for ML receivers. In the MMSE case, the denominator includes a “+1” term that prevents the clean cancellation of the term

$${\hat{h}}^{H} {\hat{R}}_{nn}^{- 1} \hat{h}$$

when the determinant is involved. Thus, for MMSE, the computed SNR is an approximation.

Once all relevant SNR values are available, the MRC/SISO selection architecture 100 selects between MRC and SISO according to the following logic:
1. First, compute:
   SNRₘₐₓ=max (SNR₀, SNR₁)
   SNRₘᵢₙ=min(SNR₀, SNR₁)
   SNR_{MRC}=estimated post-processing MRC SNR
   ΔSNR=SNR_{MRC}−SNRₘᵢₙ
2. The MRC/SISO selection architecture 100 then dynamically selects between MRC and SISO reception modes on a per-packet basis, depending on the estimated channel and noise conditions of each antenna chain, as is expressed by the estimated SNR. The selection criterion is governed by a reception mode selector variable THR_MODE, which is the configuration input to the MRC/SISO selection block 140 that controls a threshold mode (THR_MODE) that determines the criteria for switching from the MRC to the SISO reception mode. There are three threshold mode configurations:
If any of the following conditions are met:
   THR_MODE==0 and SNRₘₐₓ>THR_ABS_SNR
   THR_MODE==1 and SNR_{MRC}−SNRₘₐₓ<THR_DIFF_SNR
   THR_MODE==2 and (SNRₘₐₓ>THR_ABS_SNR or SNR_{MRC}−SNRₘₐₓ<THR_DIFF_SNR), then only the antenna chain with the higher SNR is used, and the other antenna chain is disabled. This implies that either the strongest antenna chain alone suffices for decoding (low PER), or the incremental gain from MRC is too small to justify its power cost.

Otherwise, the MRC/SISO selection architecture 100 continues in full MRC reception mode.

This approach allows for the release of resources otherwise allocated to MRC processing, thereby reducing unnecessary power consumption while maintaining optimal reception performance. As a result, a Bluetooth modem implementing this dynamic selection can achieve a significant improvement in range-related key performance indicators (KPIs) through the use of MRC gain, while maintaining similar power consumption in most use cases-thus preserving battery life.

While Bluetooth is a particularly well-suited application for this MRC/SISO selection architecture 100 due to its frequency-hopping nature, the MRC/SISO selection architecture 100 is also applicable to other wireless communication technologies. An advantage of this approach lies in its per-packet, real-time decision-making process, which does not rely on historical data. This makes it especially effective in environments where channel conditions change rapidly and unpredictably—such as in systems employing frequency hopping or operating in highly dynamic interference environments. Because the reception mode (SISO or MRC) is selected anew for each packet based on current channel metrics, the MRC/SISO selection architecture 100 remains robust even when there is little or no correlation between consecutive packets. Although technologies without frequency hopping may use historical data to inform reception mode selection, this MRC/SISO selection architecture 100 offers a more responsive and adaptable alternative for systems where such correlation cannot be assumed.

While the dynamic MRC/SISO reception mode selection architecture 100 is illustrated with two antenna chains in FIG. 1, the principles and techniques described herein may be extended to implementations having any number of antenna chains. The architecture's ability to estimate SNR metrics, perform channel estimation, and dynamically select between MRC and SISO reception modes can be applied across multiple antenna chains, with the selection logic adapted to evaluate and compare SNR values across all available chains to determine the optimal reception configuration. This scalability allows the system to maintain efficient power usage while maximizing performance gains across various multi-antenna configurations beyond the two-chain implementation shown.

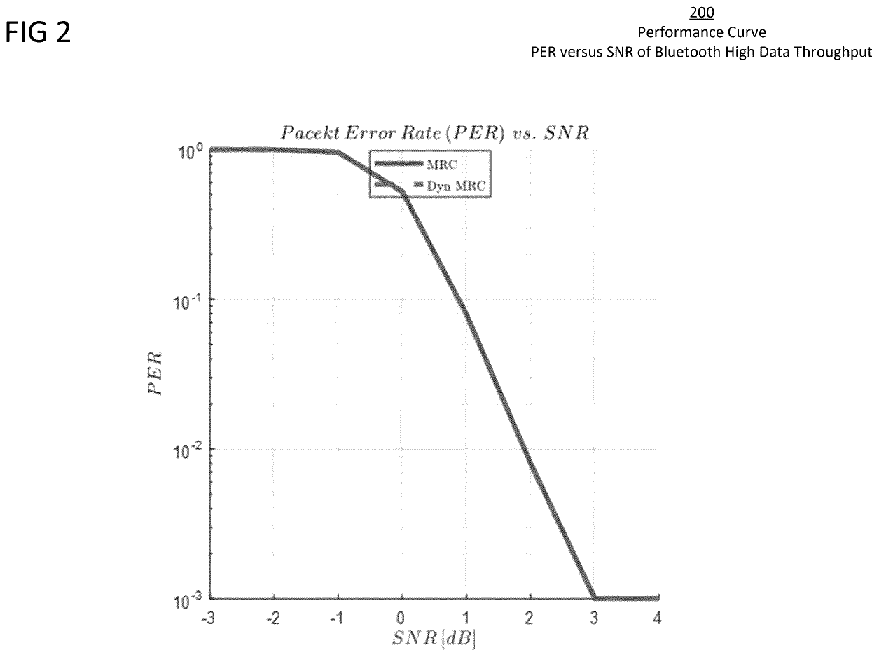

FIG. 2 illustrates a performance curve 200 of Packet Error Rate (PER) versus Signal-to-Noise Ratio (SNR) of Bluetooth High Data Throughput, in accordance with aspects of the disclosure.

The disclosed dynamic MRC reception mode selection scheme (represented by the dashed line) closely aligns with the performance of full MRC (represented by the solid line), indicating that there is no performance degradation due to the implementation of the dynamic scheme. The performance of a SISO configuration (not shown) is typically 3-5 dB worse, depending on the channel conditions.

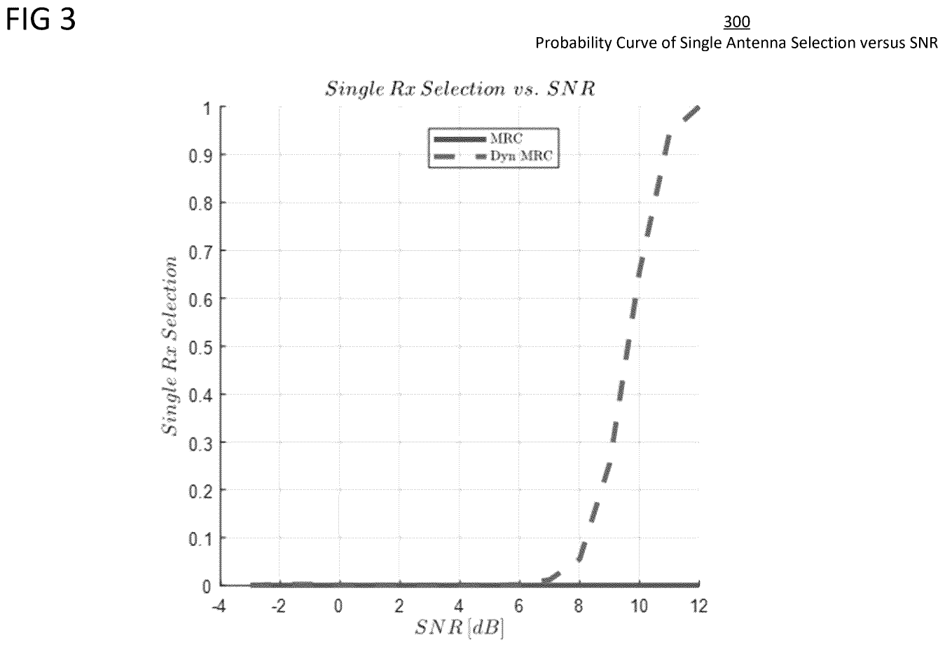

FIG. 3 illustrates a probability curve 300 of single receive antenna (SISO) reception mode selection versus SNR, in accordance with aspects of the disclosure.

The curve 300 demonstrates the probability that the disclosed dynamic MRC selection scheme will choose SISO reception mode—corresponding to a desired 50% power reduction. This scenario corresponds to the same test conditions used in the performance curve 200 of FIG. 2.

In static MRC reception mode (represented by the solid line), the probability of selecting SISO reception mode is zero, as the scheme operates in fixed MRC reception mode. In contrast, the disclosed dynamic MRC selection scheme (represented by the dashed line) selects the MRC reception mode in the low-SNR region where performance gains are desired. As SNR increases, the scheme transitions rapidly to consistently selecting SISO reception mode, achieving a probability of one. While curve 300 ends at an SNR of 12 dB, it is noted that in most real-world scenarios, SNR values exceed 12 dB. Accordingly, the disclosed scheme enables significant power savings across the majority of practical SNR operating regions.

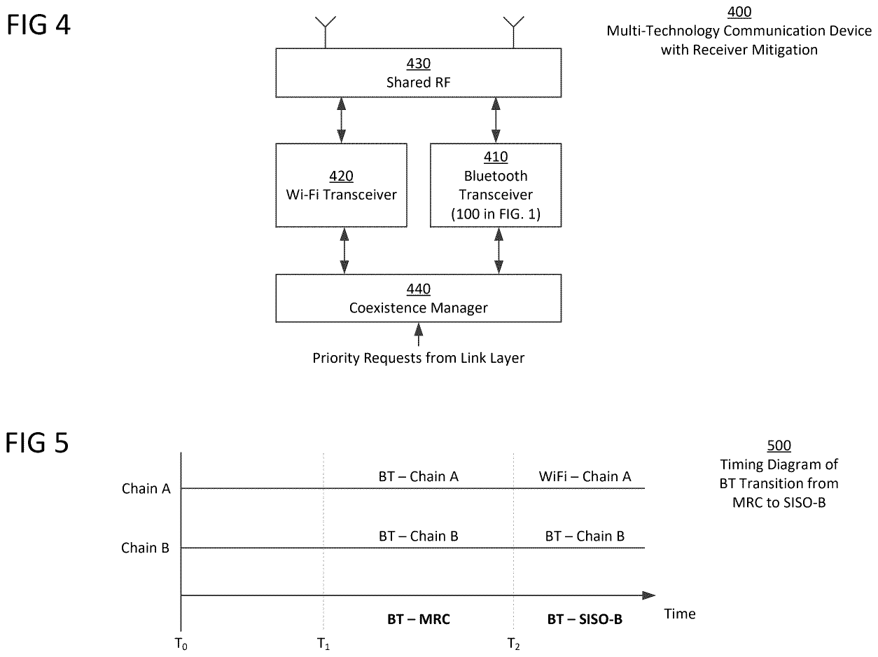

FIG. 4 illustrates a block diagram of a multi-technology communication device 400 with receiver mitigation, in accordance with aspects of the disclosure.

The multi-technology communication device 400 with receiver mitigation in this example includes two reception technologies—Wi-Fi (via Wi-Fi transceiver 420) and Bluetooth (via Bluetooth transceiver 410)—that share antennas and RF modules 430. In scenarios where Wi-Fi takes control of some of the shared resources, a coexistence manager 440 notifies the Bluetooth transceiver 410 of this event. In response, the Bluetooth transceiver switches from MRC reception to SISO reception. The Bluetooth transceiver 410 basically corresponds with the dynamic MRC/SISO reception mode selection block 100 of FIG. 1.

The coexistence manager 440 generally operates at the software level, typically within the link layer or MAC (Medium Access Control) layer, and is responsible for arbitrating access to shared resources among multiple communication technologies. Each technology may issue resource requests accompanied by associated priority levels. For instance, one technology may request access to a shared antenna or RF chain with a high-priority flag, while another technology may submit a concurrent request with a different priority designation. The coexistence manager 440 evaluates these competing requests based on their respective priorities and system policies to determine optimal resource allocation, ensuring efficient coexistence and minimizing interference between the active links.

Two mitigation approaches are available for handling scenarios in which a multi-antenna transceiver loses access to one or more antenna chains during packet reception. Both approaches rely on the prior estimation of transceiver parameters for all available reception modes—for example, in a two-antenna system, this includes SISO-A, SISO-B, and MRC.

In the first approach, if there is a priori knowledge that one of the antenna chains may become unavailable during reception (e.g., due to use by the Wi-Fi transceiver 420), the Bluetooth transceiver 410 can evaluate whether the SNR on the remaining antenna chain is sufficient. If so, it may switch from MRC to SISO reception mode following the parameter estimation phase. This is performed prior to the data demodulation, in a manner similar to the dynamic MRC approach.

In the second approach, if an antenna chain becomes unavailable during packet reception, the coexistence manager 440 can instruct the Bluetooth transceiver 410 to switch from MRC to the available SISO reception mode at any point during the packet reception.

According to the second approach, if at an arbitrary time during the packet reception, one of the chains becomes unavailable, then the coexistence manager 440 can command the Bluetooth transceiver 410 to switch from MRC to the available SISO at any time during the packet reception.

These mitigation strategies help Wi-Fi and Bluetooth transceivers avoid coexistence scheduling conflicts, reduce airtime usage and retransmissions, and ultimately improve battery life and reduce communication latency.

While the aspects described herein reference Bluetooth and Wi-Fi technologies, the principles and mechanisms disclosed are broadly applicable to any communication technologies that share common resources, such as antennas or RF front-end components. This includes, but is not limited to, systems involving cellular and Wi-Fi transceivers, or even multiple instances of the same technology operating in parallel—for example, dual Wi-Fi connections or dual cellular links. The core concept is the coexistence and coordination of different communication links that utilize shared hardware resources, requiring dynamic management to optimize performance, minimize interference, and maintain efficient use of system components.

FIG. 5 illustrates a timing diagram 500 of Bluetooth Transition from MRC to SISO, in accordance with aspects of the disclosure.

The timing diagram 500 illustrates the Bluetooth packet decoding process. At the start of the packet (between times T₀ and T₁), the Bluetooth transceiver 410 operates in MRC reception mode, utilizing both antennas. During this period, the Bluetooth transceiver 410 estimates the necessary parameters for both MRC and SISO reception schemes—such as channel state information, symbol timing, and frequency offset. Certain parameters, like channel estimation, differ between MRC and SISO reception modes. At time T₁, the Bluetooth transceiver 410 begins decoding the packet in MRC reception mode.

In the first approach, if a priori information is available from the coexistence manager 440 indicating that Wi-Fi prefers to use a specific antenna chain (e.g., due to higher SNR for Wi-Fi reception), and that it may need this chain during Bluetooth reception, the Bluetooth transceiver 410 can evaluate whether the SISO SNR on the other chain (the one not expected to be used by Wi-Fi) is sufficient. If so, it may switch to SISO reception mode using that chain, thereby releasing the preferred chain for Wi-Fi use.

In a second approach, the Bluetooth transceiver 410 begins reception in MRC reception mode at time T₁. At an arbitrary later time T₂, the coexistence manager 440 informs the Bluetooth transceiver 410 that only chain B remains available (e.g., Wi-Fi has claimed chain A). In response, the Bluetooth transceiver 410 switches to SISO reception mode, using the SISO-B parameters that were estimated earlier during the channel estimation period.

Time T₂ marks the transition point from MRC to SISO reception mode. Before this time, the Bluetooth transceiver 410 could utilize both antenna chains A and B and thus operate in MRC reception mode. After time T₂, it is expected to use only antenna chain B, as antenna chain A is now in use by the Wi-Fi system and is no longer available to the Bluetooth transceiver 410.

The multi-technology communication device 400 is not limited to the specific number or type of antenna chains and communication technologies illustrated in the example of FIG. 4. Rather, the device architecture and mitigation techniques described herein are scalable and extendable to accommodate any number of antenna chains and any combination of communication technologies, including future or proprietary wireless protocols. The principles of dynamic resource arbitration, coexistence management, and adaptive reception mode switching apply broadly to diverse system configurations, ensuring the disclosed techniques remain applicable across a wide range of implementations.

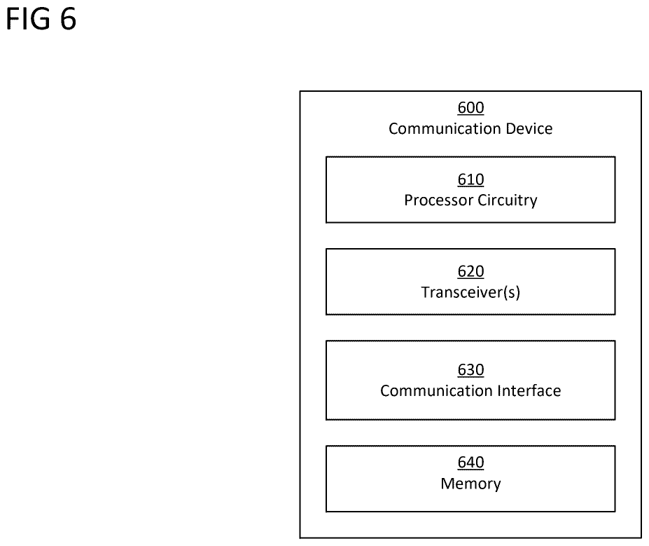

FIG. 6 illustrates a communication device 600 in accordance with aspects of the disclosure.

The communication device 600 may be identified with a central controller and be implemented as any suitable network infrastructure component, which may be implemented as a cloud/edge network server, controller, communication device, etc. The communication device 600 may serve the dynamic MRC/SISO selection architecture 100, in accordance with the various techniques discussed herein. To do so, the communication device 600 may include processor circuitry 610, a transceiver 620, a communication interface 630, and a memory 640. The components shown in FIG. 6 are provided for ease of explanation, and the communication device 600 may implement additional, fewer, or alternative components than those shown in FIG. 6.

The processor circuitry 610 may be operable as any suitable number and/or type of computer processor that may function to control the communication device 600. The processor circuitry 610 may be identified with one or more processors (or suitable portions thereof) implemented by the communication device 600. The processor circuitry 610 may be identified with one or more processors such as a host processor, a digital signal processor, one or more microprocessors, graphics processors, baseband processors, microcontrollers, an application-specific integrated circuit (ASIC), a portion (or the entirety of) a field-programmable gate array (FPGA), etc.

In any case, the processor circuitry 610 may be operable to execute instructions to perform arithmetic, logic, and/or input/output (I/O) operations and/or to control the operation of one or more components of the communication device 600 to perform various functions as described herein. The processor circuitry 610 may include one or more microprocessor cores, memory registers, buffers, clocks, etc. It may generate electronic control signals associated with the components of the communication device 600 to control and/or modify the operation of those components. The processor circuitry 610 may communicate with and/or control functions associated with the transceiver 620, the communication interface 630, and/or the memory 640. The processor circuitry 610 may additionally perform various operations to control the communications, communications scheduling, and/or operation of other network infrastructure components communicatively coupled to the communication device 600.

The transceiver 620 may be implemented as any suitable number and/or type of components operable to transmit and/or receive data packets and/or wireless signals in accordance with any suitable number and/or type of communication protocols. The transceiver 620 may include any suitable type of components to facilitate this functionality, including components associated with known transceiver, transmitter, and/or receiver operations, configurations, and implementations. Although shown as a transceiver in FIG. 6, the transceiver 620 may include any suitable number of transmitters, receivers, or combinations thereof, which may be integrated into a single transceiver or as multiple transceivers or transceiver modules. The transceiver 620 may include components typically identified with a radio frequency (RF) front end and include, for example, antennas, ports, power amplifiers (PAs), RF filters, mixers, local oscillators (LOs), low noise amplifiers (LNAs), up-converters, down-converters, channel tuners, etc.

The communication interface 630 may be implemented as any suitable number and/or type of components operable to facilitate the transceiver 620 to receive and/or transmit data and/or signals in accordance with one or more communication protocols, as discussed herein. The communication interface 630 may be implemented as any suitable number and/or type of components operable to interface with the transceiver 620, such as analog-to-digital converters (ADCs), digital-to-analog converters, intermediate frequency (IF) amplifiers and/or filters, modulators, demodulators, baseband processors, and the like. The communication interface 630 may thus operate in conjunction with the transceiver 620 and form part of an overall communication circuitry implemented by the communication device 600, which may be implemented via the communication device 600 to transmit commands and/or control signals to perform any of the functions described herein.

The memory 640 is operable to store data and/or instructions such that when the instructions are executed by the processor circuitry 610, they cause the communication device 600 to perform various functions as described herein. The memory 640 may be implemented as any known volatile and/or non-volatile memory, including, for example, read-only memory (ROM), random access memory (RAM), flash memory, a magnetic storage medium, an optical disk, erasable programmable read-only memory (EPROM), programmable read-only memory (PROM), etc. The memory 640 may be non-removable, removable, or a combination of the two. The memory 640 may be implemented as a non-transitory computer-readable medium storing one or more executable instructions such as logic, algorithms, code, etc.

As further discussed below, the instructions, logic, code, etc., stored in the memory 640 are represented by the various modules/engines as shown in FIG. 6. Alternatively, when implemented via hardware, the modules/engines shown in FIG. 6 associated with the memory 640 may include instructions and/or code to facilitate control and/or monitoring of the operation of such hardware components. In other words, the modules/engines shown in FIG. 6 are provided to facilitate an explanation of the functional association between hardware and software components. Thus, the processor circuitry 610 may execute the instructions stored in these respective modules/engines in conjunction with one or more hardware components to perform the various functions discussed herein.

The techniques of this disclosure may also be described in the following examples.

Example 1. An apparatus, comprising: a plurality of antenna chains configured to receive a wireless packet; and processor circuitry configured to: estimate respective signal-to-noise ratios (SNRs) for the plurality of antenna chains based on a preamble portion of the received wireless packet; and select, for the received wireless packet: (a) a single-input single-output (SISO) reception mode in which reception is performed via one of the plurality of antenna chains, or (b) a maximum ratio combining (MRC) reception mode in which reception is performed via the plurality of antenna chains, based on the estimated SNRs.

Example 2. The apparatus of example 1, wherein the processor circuitry is configured to select the SISO reception mode by retaining the antenna chain with a higher SNR and deactivating one or more of remaining antenna based on, based on the higher SNR among the antenna chains being greater than a predefined absolute threshold.

Example 3. The apparatus of any one of examples 1-2, wherein the processor circuitry is configured to select the SISO reception mode by retaining the antenna chain with a higher SNR and deactivating one or more of remaining antenna chains, based on a difference between an estimated post-MRCSNR and the higher SNR among the antenna chains being less than a predefined difference threshold.

Example 4. The apparatus of any one of examples 1-3, wherein the processor circuitry is configured to select the SISO reception mode by retaining the antenna chain with a higher SNR and deactivating one or more of remaining antenna chains, if: (a) a higher SNR is greater than a predefined absolute threshold; or (b) a difference between an estimated post-MRCSNR and the higher SNR is less than a predefined difference threshold.

Example 5. The apparatus of any one of examples 1-4, wherein the processor circuitry is configured to select the MRC reception mode if: (a) a higher SNR is less than a predefined absolute threshold; and (b) a difference between an estimated post-MRCSNR and the higher SNR is greater than a predefined difference threshold.

Example 6. The apparatus of any one of examples 1-5, wherein the processor circuitry is configured to deactivate at least one of the antenna chains when the SISO reception mode is selected.

Example 7. The apparatus of any one of examples 1-6, wherein the processor circuitry is configured to select between the SISO and MRC reception modes on a per-packet basis.

Example 8. The apparatus of any one of examples 1-7, wherein the processor circuitry is configured to estimate the SNRs based on channel state information and a noise correlation matrix determined from the preamble portion of the received wireless packet.

Example 9. The apparatus of any one of examples 1-8, wherein the apparatus operates in accordance with a Bluetooth communication protocol.

Example 10. The apparatus of any one of examples 1-9, wherein the processor circuitry performs the reception mode selection prior to decoding a data portion of the received wireless packet.

Example 11. The apparatus of any one of examples 1-10, wherein the processor circuitry is configured to: enable the plurality of antenna chains prior to reception of the wireless packet; determine SNR metrics over the preamble portion of the received wireless packet; and deactivate one or more of the antenna chains based on SISO reception mode being selected.

Example 12. The apparatus of any one of examples 1-11, wherein the processor circuitry is configured to: determine a maximum SNR, a minimum SNR from the estimated SNRs, and an MRC SNR; determine an SNR delta as a difference between the MRC SNR and the maximum SNR; and use the maximum SNR, the minimum SNR, and the SNR delta in determining whether to select the SISO or MRC reception mode.

Example 13. The apparatus of any one of examples 1-12, wherein the processor circuitry is further configured to: estimate reception parameters for the SISO reception mode and the MRC reception mode based on the received wireless packet; determine availability of the plurality of antenna chains during reception, including in response to at least one of the antenna chains being allocated to a coexisting communication system that shares one or more of the antenna chains; and select between the SISO reception mode and the MRC reception mode based further on the estimated reception parameters and the determined availability.

Example 14. An apparatus, comprising: a plurality of antenna chains configured to receive a wireless packet; and processor circuitry configured to: estimate reception parameters for a maximum ratio combining (MRC) reception mode that utilizes the plurality of antenna chains and a single-input single-output (SISO) reception mode that utilizes an antenna chain of the plurality of antenna chains based on the received wireless packet; determine availability of the plurality of antenna chains during packet reception, including in response to at least one of the plurality of antenna chains being allocated to a coexisting communication system that shares an antenna chain of the plurality of antenna chains; and select between the MRC reception mode and the SISO reception mode for receiving the wireless packet based on the estimated reception parameters and the determined availability.

Example 15. The apparatus of example 14, wherein the processor circuitry is configured to, based on a-priori information indicating a likelihood that one of the plurality of antenna chains is expected to become unavailable, evaluate whether a signal-to-noise ratio for the SISO reception mode is greater than a threshold, and if so, initiate the SISO reception mode prior to packet decoding.

Example 16. The apparatus of any one of examples 14-15, wherein the processor circuitry is configured to switch from the MRC reception mode to the SISO reception mode during reception of the wireless packet based on at least one of the receive antenna chains becoming unavailable.

Example 17. The apparatus of any one of examples 14-16, wherein the processor circuitry is configured to release the shared antenna chain for use by the coexisting communication system by switching from the MRC reception mode to the SISO reception mode.

Example 18. The apparatus of any one of examples 14-17, wherein the apparatus is a Bluetooth apparatus and the coexisting communication system is a Wi-Fi communication system.

Example 19. At least one non-transitory computer-readable medium comprising instructions stored thereon, that if executed by one or more processors, cause the one or more processors to: estimate respective signal-to-noise ratios (SNRs) for a plurality of antenna chains based on a preamble portion of a received wireless packet; and select, for the received wireless packet: (a) a single-input single-output (SISO) reception mode in which reception is performed via one of the plurality of antenna chains, or (b) a maximum ratio combining (MRC) reception mode in which reception is performed via the plurality of antenna chains, based on the estimated SNRs.

Example 20. The at least one non-transitory computer-readable medium of example 19, wherein the instructions further cause the one or more processors to select the SISO reception mode by retaining the antenna chain with a higher SNR and deactivating one or more of remaining antenna chains, based on the higher SNR among the antenna chains being greater than a predefined absolute threshold.

Example 21. The at least one non-transitory computer-readable medium of any one of examples 19-20, wherein the instructions further cause the one or more processors to select the SISO reception mode by retaining the antenna chain with a higher SNR and deactivating one or more of remaining antenna chains, based on a difference between an estimated post-MRCSNR and the higher SNR among the antenna chains being less than a predefined difference threshold.

Example 22. The at least one non-transitory computer-readable medium of any one of examples 19-21, wherein the instructions further cause the one or more processors to select the SISO reception mode by retaining the antenna chain with a higher SNR and deactivating one or more of remaining antenna chains, if: (a) a higher SNR is greater than a predefined absolute threshold; or (b) a difference between an estimated post-MRCSNR and the higher SNR is less than a predefined difference threshold.

Example 23. The at least one non-transitory computer-readable medium of any one of examples 19-22, wherein the instructions further cause the one or more processors to select the MRC reception mode if: (a) a higher SNR is less than a predefined absolute threshold; and (b) a difference between an estimated post-MRCSNR and the higher SNR is greater than a predefined difference threshold.

Example 24. The at least one non-transitory computer-readable medium of any one of examples 19-23, wherein the instructions further cause the one or more processors to deactivate at least one of the antenna chains when the SISO reception mode is selected.

Example 25. The at least one non-transitory computer-readable medium of any one of examples 19-24, wherein the instructions further cause the one or more processors to select between the SISO and MRC reception modes on a per-packet basis.

Example 26. The at least one non-transitory computer-readable medium of any one of examples 19-25, wherein the instructions further cause the one or more processors to estimate the SNRs based on channel state information and a noise correlation matrix determined from the preamble portion of the received wireless packet.

Example 27. The at least one non-transitory computer-readable medium of any one of examples 19-26, wherein the one or more processors are operable in accordance with a Bluetooth communication protocol.

Example 28. The at least one non-transitory computer-readable medium of any one of examples 19-27, wherein the processor circuitry performs the reception mode selection prior to decoding a data portion of the received wireless packet.

Example 29. The at least one non-transitory computer-readable medium of any one of examples 19-28, wherein the instructions further cause the one or more processors to: enable the plurality of antenna chains prior to reception of the wireless packet; determine SNR metrics over the preamble portion of the received wireless packet; and deactivate one or more of the antenna chains based on SISO reception mode being selected.

Example 30. The at least one non-transitory computer-readable medium of any one of examples 19-29, wherein the instructions further cause the one or more processors to: determine a maximum SNR, a minimum SNR from the estimated SNRs, and an MRC SNR; determine an SNR delta as a difference between the MRC SNR and the maximum SNR; and use the maximum SNR, the minimum SNR, and the SNR delta in determining whether to select the SISO or MRC reception mode.

Example 31. The at least one non-transitory computer-readable medium of example 19, wherein the instructions further cause the one or more processors to: estimate reception parameters for the SISO reception mode and the MRC reception mode based on the received wireless packet; determine availability of the plurality of antenna chains during reception, including in response to at least one of the antenna chains being allocated to a coexisting communication system that shares one or more of the antenna chains; and select between the SISO reception mode and the MRC reception mode based further on the estimated reception parameters and the determined availability.

Example 32. At least one non-transitory computer-readable medium comprising instructions stored thereon, that if executed by one or more processors, cause the one or more processors to: estimate reception parameters for a maximum ratio combining (MRC) reception mode that utilizes the plurality of antenna chains and a single-input single-output (SISO) reception mode that utilizes an antenna chain of the plurality of antenna chains based on a received wireless packet; determine availability of the plurality of antenna chains during packet reception, including in response to at least one of the plurality of antenna chains being allocated to a coexisting communication system that shares an antenna chain of the plurality of antenna chains; and select between the MRC reception mode and the SISO reception mode for receiving the wireless packet based on the estimated reception parameters and the determined availability.

Example 33. The at least one non-transitory computer-readable medium of example 32, wherein the instructions further cause the one or more processors to, based on a-priori information indicating a likelihood that one of the plurality of antenna chains is expected to become unavailable, evaluate whether a signal-to-noise ratio for the SISO reception mode is greater than a threshold, and if so, initiate the SISO reception mode prior to packet decoding.

Example 34. The at least one non-transitory computer-readable medium of any one of examples 32-33, wherein the instructions further cause the one or more processors to switch from the MRC reception mode to the SISO reception mode during reception of the wireless packet based on at least one of the receive antenna chains becoming unavailable.

Example 35. The at least one non-transitory computer-readable medium of any one of examples 32-34, wherein the instructions further cause the one or more processors to release the shared antenna chain for use by the coexisting communication system by switching from the MRC reception mode to the SISO reception mode.

Example 36. The at least one non-transitory computer-readable medium of any one of examples 32-35, wherein the one or more processors are operable in accordance with a Bluetooth protocol and the coexisting communication system is a Wi-Fi communication system.

Example 37. A method, comprising: receiving a wireless packet by a plurality of antenna chains; estimating respective signal-to-noise ratios (SNRs) for the plurality of antenna chains based on a preamble portion of the received wireless packet; and selecting, for the received wireless packet: (a) a single-input single-output (SISO) reception mode in which reception is performed via one of the plurality of antenna chains, or (b) a maximum ratio combining (MRC) reception mode in which reception is performed via the plurality of antenna chains, based on the estimated SNRs.

Example 38. The method of example 37, further comprising: selecting the SISO reception mode by retaining the antenna chain with a higher SNR and deactivating one or more of remaining antenna chains, based on the higher SNR among the antenna chains being greater than a predefined absolute threshold.

Example 39. The method of any one of examples 37-38, further comprising: selecting the SISO reception mode by retaining the antenna chain with a higher SNR and deactivating one or more of remaining antenna chains, based on a difference between an estimated post-MRCSNR and the higher SNR among the antenna chains being less than a predefined difference threshold.

Example 40. The method of any one of examples 37-39, further comprising selecting the SISO reception mode by retaining the antenna chain with a higher SNR and deactivating one or more of remaining antenna chains, if: (a) a higher SNR is greater than a predefined absolute threshold; or (b) a difference between an estimated post-MRCSNR and the higher SNR is less than a predefined difference threshold.

Example 41. The method of any one of examples 27-40, further comprising: selecting the MRC reception mode if: (a) a higher SNR is less than a predefined absolute threshold; and (b) a difference between an estimated post-MRCSNR and the higher SNR is greater than a predefined difference threshold.

Example 42. The method of any one of examples 37-41, further comprising: deactivating at least one of the antenna chains when the SISO reception mode is selected.

Example 43. The method of any one of examples 37-42, further comprising: selecting between the SISO and MRC reception modes on a per-packet basis.

Example 44. The method of any one of examples 37-43, further comprising: estimating the SNRs based on channel state information and determine a noise correlation matrix from the preamble portion of the received wireless packet.

Example 45. The method of any one of examples 37-44, wherein the method operates in accordance with a Bluetooth communication protocol.

Example 46. The method of any one of examples 37-45, further comprising: selecting the reception mode prior to decoding a data portion of the received wireless packet.

Example 47. The method of any one of examples 37-46, further comprising: enabling the plurality of antenna chains prior to reception of the wireless packet; determining SNR metrics over the preamble portion of the received wireless packet; and deactivating one or more of the antenna chains based on SISO reception mode being selected.

Example 48. The method of any one of examples 37-47, further comprising: determining a maximum SNR, a minimum SNR from the estimated SNRs, and an MRC SNR; determining an SNR delta as a difference between the MRC SNR and the maximum SNR; and using the maximum SNR, the minimum SNR, and the SNR delta in determining whether to select the SISO or MRC reception mode.

Example 49. The method of any one of examples 37-48, further comprising: estimating reception parameters for the SISO reception mode and the MRC reception mode based on the received wireless packet; determining availability of the plurality of antenna chains during reception, including in response to at least one of the antenna chains being allocated to a coexisting communication system that shares one or more of the antenna chains; and selecting between the SISO reception mode and the MRC reception mode based further on the estimated reception parameters and the determined availability.

Example 50. An method, comprising: receiving a wireless packet by a plurality of antenna chains; estimating reception parameters for a maximum ratio combining (MRC) reception mode that utilizes the plurality of antenna chains and a single-input single-output (SISO) reception mode that utilizes an antenna chain of the plurality of antenna chains based on the received wireless packet; determining availability of the plurality of antenna chains during packet reception, including in response to at least one of the plurality of antenna chains being allocated to a coexisting communication system that shares an antenna chain of the plurality of antenna chains; and selecting between the MRC reception mode and the SISO reception mode for receiving the wireless packet based on the estimated reception parameters and the determined availability.

Example 51. The method of example 50, further comprising: based on a-priori information indicating a likelihood that one of the plurality of antenna chains is expected to become unavailable, evaluating whether a signal-to-noise ratio for the SISO reception mode is greater than a threshold, and if so, initiating the SISO reception mode prior to packet decoding.

Example 52. The method of any one of examples 50-51, further comprising: switching from the MRC reception mode to the SISO reception mode during reception of the wireless packet based on at least one of the receive antenna chains becoming unavailable.

Example 53. The method of any one of examples 50-52, further comprising: releasing the shared antenna chain for use by the coexisting communication system by switching from the MRC reception mode to the SISO reception mode.

Example 54. The method of any one of examples 50-53, wherein the method is a Bluetooth method and the coexisting communication system is a Wi-Fi communication system.

Although specific aspects have been illustrated and described herein, it will be appreciated by those of ordinary skill in the art that a variety of alternate and/or equivalent implementations may be substituted for the specific aspects shown and described without departing from the scope of the disclosure. This application is intended to cover any adaptations or variations of the specific aspects discussed herein.

1. An apparatus, comprising:
a plurality of antenna chains configured to receive a wireless packet; and
processor circuitry configured to:
estimate respective signal-to-noise ratios (SNRs) for the plurality of antenna chains based on a preamble portion of the received wireless packet; and
select, for the received wireless packet: (a) a single-input single-output (SISO) reception mode in which reception is performed via one of the plurality of antenna chains, or (b) a maximum ratio combining (MRC) reception mode in which reception is performed via the plurality of antenna chains, based on the estimated SNRs.

2. The apparatus of claim 1, wherein the processor circuitry is configured to select the SISO reception mode by retaining the antenna chain with a higher SNR and deactivating one or more of remaining antenna chains, based on the higher SNR among the antenna chains being greater than a predefined absolute threshold.

3. The apparatus of claim 1, wherein the processor circuitry is configured to select the SISO reception mode by retaining the antenna chain with a higher SNR and deactivating one or more of remaining antenna chains, based on a difference between an estimated post-MRCSNR and the higher SNR among the antenna chains being less than a predefined difference threshold.

4. The apparatus of claim 1, wherein the processor circuitry is configured to select the SISO reception mode by retaining the antenna chain with a higher SNR and deactivating one or more of remaining antenna chains, if: (a) a higher SNR is greater than a predefined absolute threshold; or (b) a difference between an estimated post-MRCSNR and the higher SNR is less than a predefined difference threshold.

5. The apparatus of claim 1, wherein the processor circuitry is configured to select the MRC reception mode if: (a) a higher SNR is less than a predefined absolute threshold; and (b) a difference between an estimated post-MRCSNR and the higher SNR is greater than a predefined difference threshold.

6. The apparatus of claim 1, wherein the processor circuitry is configured to deactivate at least one of the antenna chains when the SISO reception mode is selected.

7. The apparatus of claim 1, wherein the processor circuitry is configured to select between the SISO and MRC reception modes on a per-packet basis.

8. The apparatus of claim 1, wherein the processor circuitry is configured to estimate the SNRs based on channel state information and a noise correlation matrix determined from the preamble portion of the received wireless packet.

9. The apparatus of claim 1, wherein the apparatus operates in accordance with a Bluetooth communication protocol.

10. The apparatus of claim 1, wherein the processor circuitry performs the reception mode selection prior to decoding a data portion of the received wireless packet.

11. The apparatus of claim 1, wherein the processor circuitry is configured to:
enable the plurality of antenna chains prior to reception of the wireless packet;
determine SNR metrics over the preamble portion of the received wireless packet; and
deactivate one or more of the antenna chains based on SISO reception mode being selected.

12. The apparatus of claim 1, wherein the processor circuitry is configured to:
determine a maximum SNR, a minimum SNR from the estimated SNRs, and an MRC SNR;
determine an SNR delta as a difference between the MRC SNR and the maximum SNR; and
use the maximum SNR, the minimum SNR, and the SNR delta in determining whether to select the SISO or MRC reception mode.

13. The apparatus of claim 1, wherein the processor circuitry is further configured to:
estimate reception parameters for the SISO reception mode and the MRC reception mode based on the received wireless packet;
determine availability of the plurality of antenna chains during reception, including in response to at least one of the antenna chains being allocated to a coexisting communication system that shares one or more of the antenna chains; and
select between the SISO reception mode and the MRC reception mode based further on the estimated reception parameters and the determined availability.

14. An apparatus, comprising:
a plurality of antenna chains configured to receive a wireless packet; and
processor circuitry configured to:
estimate reception parameters for a maximum ratio combining (MRC) reception mode that utilizes the plurality of antenna chains and a single-input single-output (SISO) reception mode that utilizes an antenna chain of the plurality of antenna chains based on the received wireless packet;
determine availability of the plurality of antenna chains during packet reception, including in response to at least one of the plurality of antenna chains being allocated to a coexisting communication system that shares an antenna chain of the plurality of antenna chains; and
select between the MRC reception mode and the SISO reception mode for receiving the wireless packet based on the estimated reception parameters and the determined availability.

15. The apparatus of claim 14, wherein the processor circuitry is configured to, based on a-priori information indicating a likelihood that one of the plurality of antenna chains is expected to become unavailable, evaluate whether a signal-to-noise ratio for the SISO reception mode is greater than a threshold, and if so, initiate the SISO reception mode prior to packet decoding.

16. The apparatus of claim 14, wherein the processor circuitry is configured to switch from the MRC reception mode to the SISO reception mode during reception of the wireless packet based on at least one of the receive antenna chains becoming unavailable.

17. The apparatus of claim 14, wherein the processor circuitry is configured to release the shared antenna chain for use by the coexisting communication system by switching from the MRC reception mode to the SISO reception mode.

18. The apparatus of claim 14, wherein the apparatus is a Bluetooth apparatus and the coexisting communication system is a Wi-Fi communication system.

19. At least one non-transitory computer-readable medium comprising instructions stored thereon, that if executed by one or more processors, cause the one or more processors to:
estimate respective signal-to-noise ratios (SNRs) for a plurality of antenna chains based on a preamble portion of a received wireless packet; and
select, for the received wireless packet: (a) a single-input single-output (SISO) reception mode in which reception is performed via one of the plurality of antenna chains, or (b) a maximum ratio combining (MRC) reception mode in which reception is performed via the plurality of antenna chains, based on the estimated SNRs.

20. The at least one non-transitory computer-readable medium of claim 19, wherein the instructions further cause the one or more processors to:
estimate reception parameters for the SISO reception mode and the MRC reception mode based on the received wireless packet;
determine availability of the plurality of antenna chains during reception, including in response to at least one of the antenna chains being allocated to a coexisting communication system that shares one or more of the antenna chains; and
select between the SISO reception mode and the MRC reception mode based further on the estimated reception parameters and the determined availability.
